(19) United States
(12) Patent Application Publication
(10) Pub. No.: US 2007/0064805 A1
(43) Pub. Date: Mar. 22, 2007

(54) Motion vector selection

(75) Inventors: James J. Carrig, San Jose, CA (US); Marco Paniconi, Campbell, CA (US); Zhourong Miao, San Jose, CA (US)

Correspondence Address: JEFFREY SAM SMITH, 51 EAST CAMPBELL AVENUE, CAMPBELL, CA, 95008, US

(73) Assignees: Sony Corporation; Sony Electronics Inc.

(21) Appl. No.: 11/228,919

(22) Filed: Sep. 16, 2005

(51) Int. Cl. H04N 11/02; H04B 1/66

(52) U.S. Cl. 375/240.16; 375/240.27

(57) ABSTRACT

A method of selecting motion vectors includes receiving a set of motion vectors and a target rate, and using a rate-distortion criterion to modify the set of motion vectors.

### FIELD OF INVENTION

The invention is related to the field of video compression.

### BACKGROUND

Motion vectors are commonly used in image coding to facilitate the approximation of a target image (which may be a frame, a field, or a portion thereof) with respect to one or more reference images. This approximated target image is called the compensated image. The approximation procedure tiles the target image into fixed size blocks and assigns a motion vector to each block so as to map each block in the target image to a closely matching block on a reference image. The values for pixels in a particular block of the target image are then copied from the mapped block on the reference image. Common variations to this approximation process include adding prediction modes, taking the average of two same-sized and positioned blocks, and splitting a tile into smaller areas.

The error between the desired target image and the compensated image is then encoded. It is assumed that both the encoder and decoder have access to the same reference images. Therefore, only the motion vectors and residual error corrections are used to accomplish video coding for transmission.

A successful video coder balances many factors to generate a high-quality target image while using limited computational resources. Of all these factors, the selection of a set of motion vectors to map to reference blocks is critical to video quality and costly in terms of computational resources. Conventional video coders are unable to select a set of globally optimal motion vectors, given the limited computational resources that are available.

Therefore, there is a need for a method of selecting a set of globally optimal, or nearly globally optimal, motion vectors for predicting a target image using limited and interruptible computational resources.

### SUMMARY

A method of selecting motion vectors includes receiving a set of motion vectors and a target rate, and using a rate-distortion criterion to modify the set of motion vectors.

### BRIEF DESCRIPTION OF THE DRAWINGS

The present invention is illustrated by way of example and may be better understood by referring to the following description in conjunction with the accompanying drawings, in which:

FIG. 1 shows an example of a device for performing the motion vector selection method.

FIG. 2 shows a set of examples of shape definitions which are used in some embodiments of the shape definition library 140 shown in FIG. 1.

FIG. 3 shows another set of examples of shape definitions which are used in some embodiments of the shape definition library 140 shown in FIG. 1.

FIG. 4 shows an example of a target block that is mapped to a reference block in a reference image using a motion vector from the output selection of motion vectors.

FIG. 5 shows an example of pixels in the target image that are mapped to multiple reference blocks.

FIG. 6 shows an example of a motion vector selection method.

FIG. 7 is a graph of the reduction in distortion of the target image resulting from multiple iterations of the method of FIG. 6.

FIG. 8 shows the relative change on the rate and distortion resulting from adding or removing particular motion vectors using the method of FIG. 6.

FIG. 9 is a table showing the effects of adding or removing a motion vector from the selection of motion vectors.

FIG. 10 shows the relative change on the rate and distortion resulting from adding or removing one or more motion vectors.

FIG. 11 is a table showing the effects of adding or removing one or more motion vectors.

FIG. 12 shows an example of a method for adding a motion vector used by the method of FIG. 6.

FIG. 13 shows an example of a method of removing a motion vector used by the method of FIG. 6.

FIG. 14 shows an example of a method for encoding an image of video data using the method of FIG. 6.

FIG. 15 shows an example of a method of decoding the image.

FIG. 16 shows an example of a video system that uses the motion vector selection method.

### DETAILED DESCRIPTION

In the following description, reference is made to the accompanying drawings which form a part hereof, and in which is shown by way of illustration a specific embodiment in which the invention may be practiced. It is to be understood that other embodiments may be utilized and structural changes may be made without departing from the scope of the present invention. For example, skilled artisans will understand that the terms field or frame or image that are used to describe the various embodiments are generally interchangeable as used with reference to video data.

A motion vector selection method modifies an existing initial selection of motion vectors to derive an improved representation of the target image at a designated bit rate. In some embodiments, the method may be initialized close to a solution, the rate control can be modified at any time, and the method may be interrupted at any time, making it highly suitable as a component for real-time video coding.

The method finds a nearly optimal selection by using limited, interruptible, resources. This task is accomplished by starting with an initial selection of spatio-temporal reference images and then quickly modifying that selection to form a feasible selection. The method then continues to improve this selection until the operation either converges or reaches one or more other stopping criteria Each modified selection creates a rate-distortion improvement to approximately optimize the selection of motion vectors for the given rate.

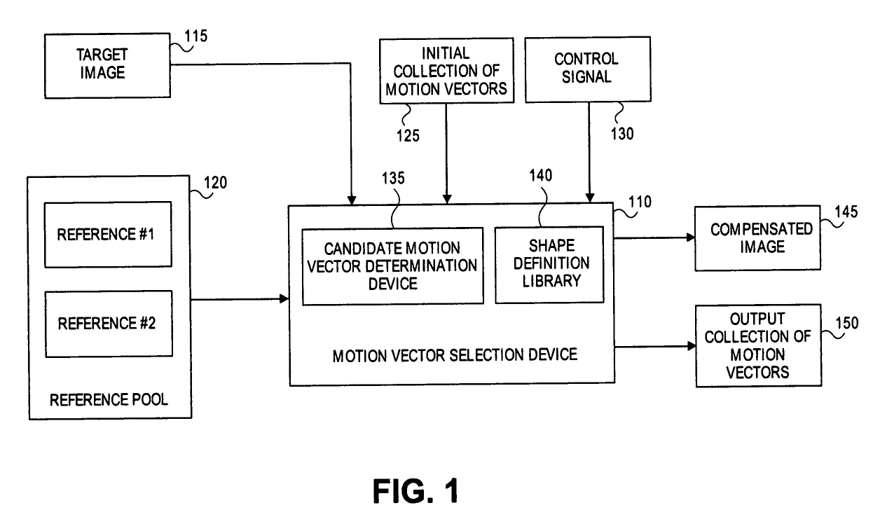

An example of a device for performing the motion vector selection method is shown in FIG. 1. The motion vector selection device 110 receives a target image 115, a set of one or more reference images from a reference pool 120, an initial collection of motion vectors (which may be empty) 125, and a control signal 130 to indicate the allowed bit rate, R_{T}, or the allowed efficiency ΔD/ΔR, where ΔD is a change in distortion.

An example of distortion, used in some embodiments, is the sum of the square difference between pixels on the compensated image and corresponding pixels on the target image. Another example of distortion is the sum of the absolute difference between corresponding pixels on the target and compensated images.

The ΔR is a change in bit rate. In some embodiments, the bit rate is the average number of bits required to encode each second of video. The target rate is the rate the algorithm seeks to attain. The current rate is the number of bits per second of video required to encode the current selection of motion vectors. Rate variance is the rate added to the target rate, which defines the acceptable bounds of iterating for the current rate.

A candidate motion vector determination device 135 uses shape definition library 140 to select an output collection of motion vectors. This output collection of motion vectors is applied to the reference images so as to form a compensated image 145 that approximates the target image 115 within the allowed parameters set by the control signal 130. The output collection of motion vectors 150 can then be encoded as part of a video compression and transmission process.

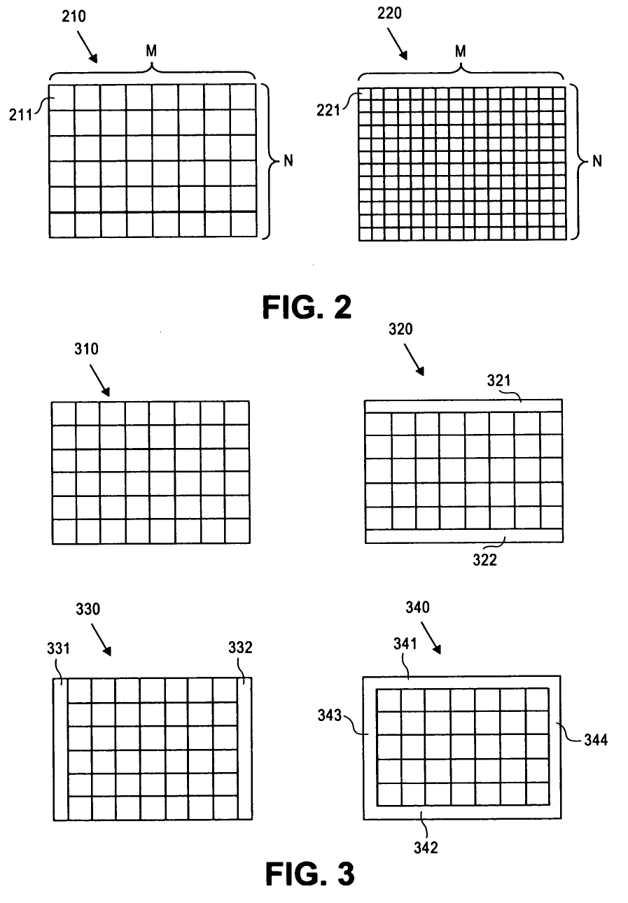

Each shape definition in shape definition library 140 refers to a collection of pixels that are compensated by a motion vector. For example, FIG. 2 shows two shape definitions for constructing reference blocks. Shape definition 210 tiles a target image of M by N pixels into a collection of non-overlapping blocks of 16 pixels by 16 pixels. For example, block 211 is a block of 16×16 pixels. Each block is represented by a motion vector (not shown). A unique motion vector ID is used to identify a particular block within a shape definition. In this example, the motion vector ID's range from 1 to (M×N)/(16×16). As another example, shape definition 220 tiles the target image into blocks of 4 by 4 pixels. For example, block 221 is a block of 4×4 pixels. The motion vector ID's for shape definition 220 range from 1 to (M×N)/(4×4). Also, a unique shape ID is used to identify each shape definition. The unique shape ID and the unique motion vector ID are used to uniquely determine a particular block in the multiple shape definitions. The shapes 210 and 220 are illustrative of shapes commonly used in video coding.

FIG. 3 shows examples of shape definitions which are used together in some embodiments of shape definition library 140. In these examples, the shape definitions are based on blocks of 16 pixels by 16 pixels. Some shape definitions have an offset to allow for more complex interactions, such as overlapping blocks. Illustrative shape definition 310 tiles a target image of M×N pixels into 16×16 pixel blocks, has a shape ID of 1, and has motion vector ID's ranging from 1 to (M×N)/(16×16). Shape definition 320 tiles a target image of M×N pixels into 16×16 blocks, with offsets 321 and 322 of 8 pixels vertically, along the upper and lower boundaries of the image. The shape ID of illustrative shape definition 320 is 2, and the motion vector ID's range from 1 to ((M−1)×N)/(16×16). Illustrative shape definition 330 tiles a target image of M×N pixels into 16×16 blocks, with offsets 331 and 332 of 8 pixels horizontally, along the left and right boundaries of the image. The shape ID for shape definition 330 is 3, and the motion vector ID's range from 1 to (M×(N−1))/(16×16). Illustrative shape definition 340 tiles a target image of M×N pixels into 16×16 blocks with offsets 341, 342 of 8 pixels vertically and offsets 343, 344 of 8 pixels horizontally. The shape ID for shape definition 340 is 4, and the motion vector ID's range from 1 to ((M−1)×(N−1))/(16×16). A combination of a shape ID and a motion vector ID are used to uniquely identify a particular block from shape definitions 310, 320, 330, and 340.

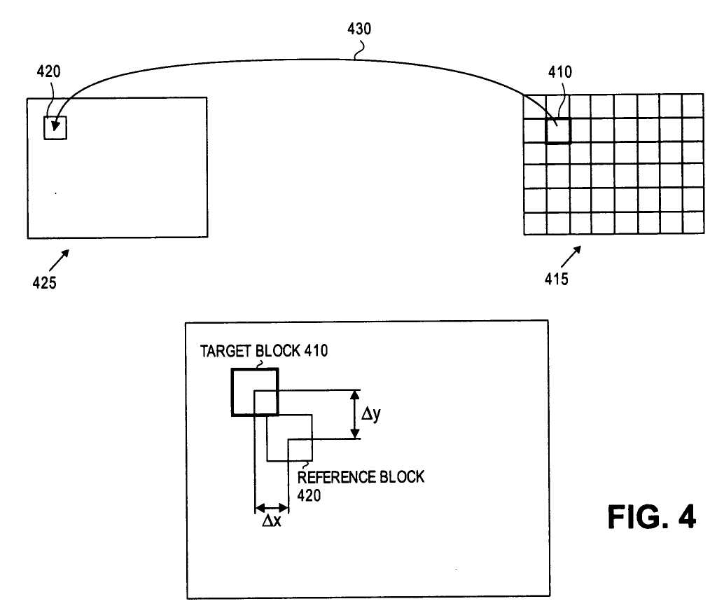

A target block 410 in target image 415 from a shape definition in library 140 (shown in FIG. 1) is mapped to a location of a corresponding reference block 420 in a reference image 425 using a motion vector 430 from the output selection of motion vectors, as shown in FIG. 4 for example. The motion vector 430 indicates an amount of motion, represented by vertical and horizontal offsets Δy and Δx, of the reference block 420 relative to the target block 410. In one embodiment, a fully specified motion vector includes a shape ID, motion vector ID, reference image ID, and horizontal and vertical offsets. When determining motion vectors as part of an encoding system, the reference images may either be original input images or their decoded counterparts.

After a reference block is identified by a motion vector, the pixel values from the reference block are copied to the corresponding target block. The compensated target image is thus generated by using the output selection of motion vectors to map target blocks to reference blocks, then copying the pixel values to the target blocks. The compensated image is generally used to approximate the target image. When constructing the compensated image as part of a video decoding system, the reference images are generally images that were previously decoded.

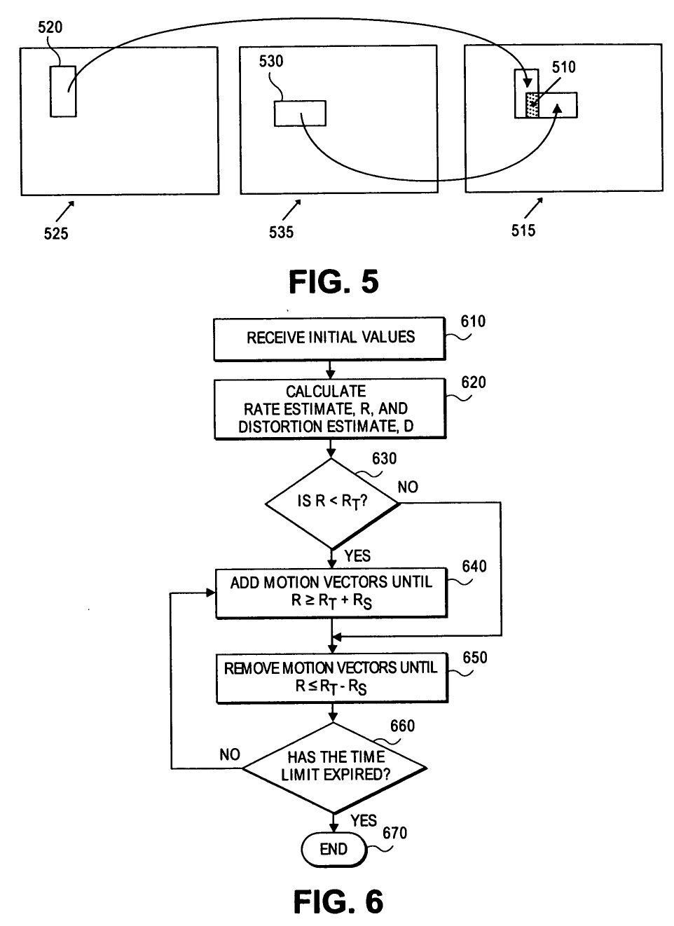

In some cases, some pixels in the target image are part of multiple target blocks, and are mapped to more than one reference block to form an overlapping area of target blocks, as shown in FIG. 5. In these cases, the value of each compensated pixel in the overlapping area 510 of compensated image 515 is determined by taking an average of the pixel values from the reference blocks 520 and 530 in reference images 525 and 535, respectively. Alternatively, a weighted average or a filtered estimate can be used. Also, in some cases, some pixels in the target image are not part of a target block and are not mapped to any reference block. These pixels can use a default value (such as 0), an interpolated value, a previously held value, or another specialized rule.

Referring again to FIG. 1, motion vector selection device 110 next selects some of the motion vectors from shape definition library 140 and discards some of the motion vectors. The compensated target image 145 is then constructed using the motion vectors in output collection of motion vectors 150, the images that they reference from reference pool 120, and the shape definitions of the blocks from shape definition library 140. Candidate motion vector determination device 135 determines if one or more motion vectors should be added to, or removed from, output collection of motion vectors 150. This determining is performed in accordance with approximately optimal rate-distortion criteria.

An example of a motion vector selection method is shown in FIG. 6. At 610, initial values (such as the initial collection of motion vectors), a target rate, a rate variance, the target image, and reference images, are received. An example of rate variance is an amount of rate overshoot and rate undershoot that is added to the target rate. The larger the rate variance, the more changes are made to the collection, but the longer it takes to return to the target rate. A rate estimate R and a distortion estimate D are calculated at 620. At 630, if the rate estimate R is less than the target rate R_{T}, then at 640 one or more motion vectors are added until the rate R exceeds the target rate R_{T} by an amount R_{S}. In some embodiments, at 640 motion vectors are added until a time limit expires. If at 630 the rate R is not less than the target rate R_{T}, or at 640 exceeds the target rate R_{T} by an amount Rs, then at 650 one or more motion vectors are removed until the difference between R_{T} and R_{S} is greater than or equal to the rate estimate R. At 650, in some embodiments, motion vectors are removed until a time limit has expired. At 660, in some embodiments, the method determines if a time limit has expired. If so, the method ends at 670. Otherwise, the method returns to 640.

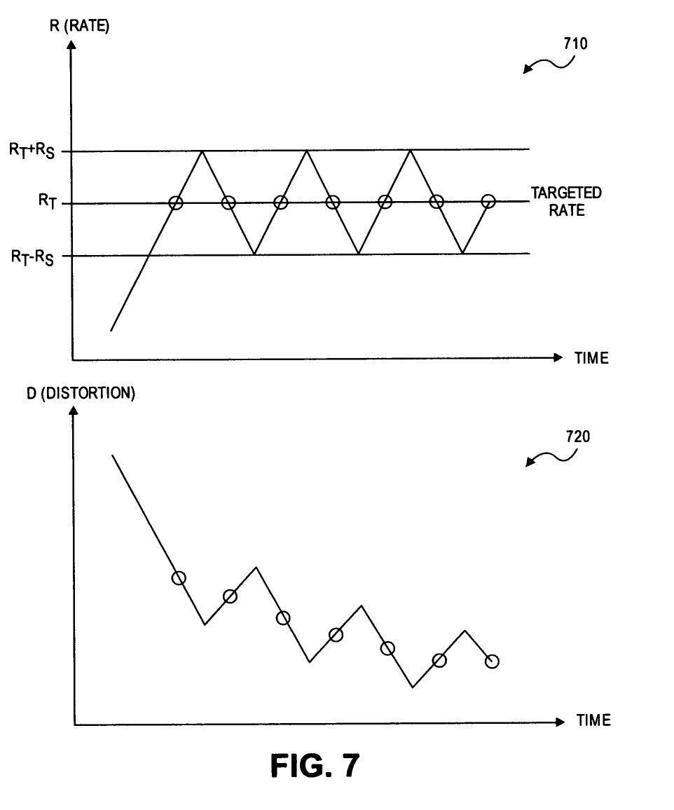

The motion vector selection method shown in FIG. 6 adds or removes motion vectors until the target rate (or in some embodiments, the target efficiency ΔD/ΔR) is reached, as shown in graph 710 of FIG. 7. After this vector selection has been accomplished, the current estimated rate oscillates around the target rate finding operating points that yield lower distortion measures as shown in graph 720. The circles in 710 and 720 indicate rate and distortion measures where the targeted rate has been met. The rate of reduction of the distortion eventually saturates, allowing the method to end without significant loss in performance.

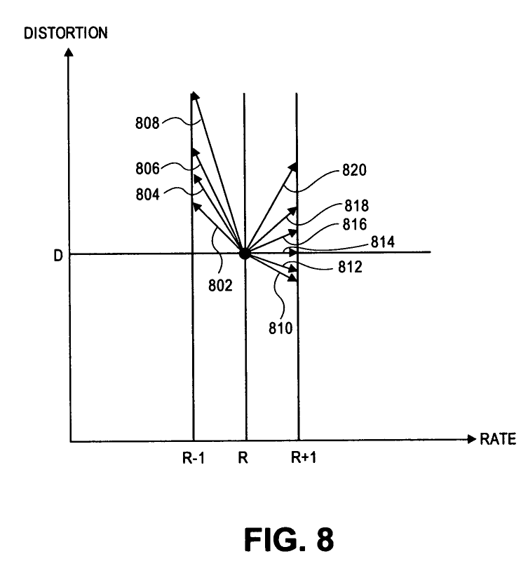

A graph showing examples of the effects of adding or removing a motion vector from the collection of candidate motion vectors is shown in FIG. 8. Starting at an operating point with rate estimate R and distortion estimate D, the method has the option to add or remove a motion vector. The rate can be modeled as being directly proportional to the number of motion vectors so that adding a motion vector increases the rate by 1 unit and removing a motion vector decreases the rate by 1 unit. The method selects the addition or deletion action that corresponds to the greatest reduction in distortion. Each arrow in FIG. 8 corresponds to a motion vector and shows the impact of the motion vector on the rate and distortion.

For example, arrows 802, 804, 806, and 808 show the effects of removing one motion vector from the collection 150. Removing the motion vector corresponding to arrow 808 causes the largest increase in image distortion. Removing the motion vector corresponding to arrow 802 causes the smallest increase in distortion. In all four cases, removing a motion vector decreases the rate by 1 unit, and increases the distortion of the compensated image. Removing a motion vector can result in a decrease in distortion, but this result is relatively rare.

Arrows 810, 812, 814, 816, 818, and 820 show the effects of adding one motion vector to the collection 150. In each case, adding a motion vector increases the rate by 1 unit. In some cases, adding a motion vector also increases the distortion. For example, arrow 820 shows that adding the corresponding motion vector to the collection 850 will increase distortion as well as increase the rate. In other cases, adding a motion vector has no effect on distortion, as shown for example by arrow 814. Adding a motion vector to the collection is efficient if the additional motion vector decreases the amount of distortion of the compensated image. Arrows 810 and 812 correspond to motion vectors that decrease the distortion if added to the collection.

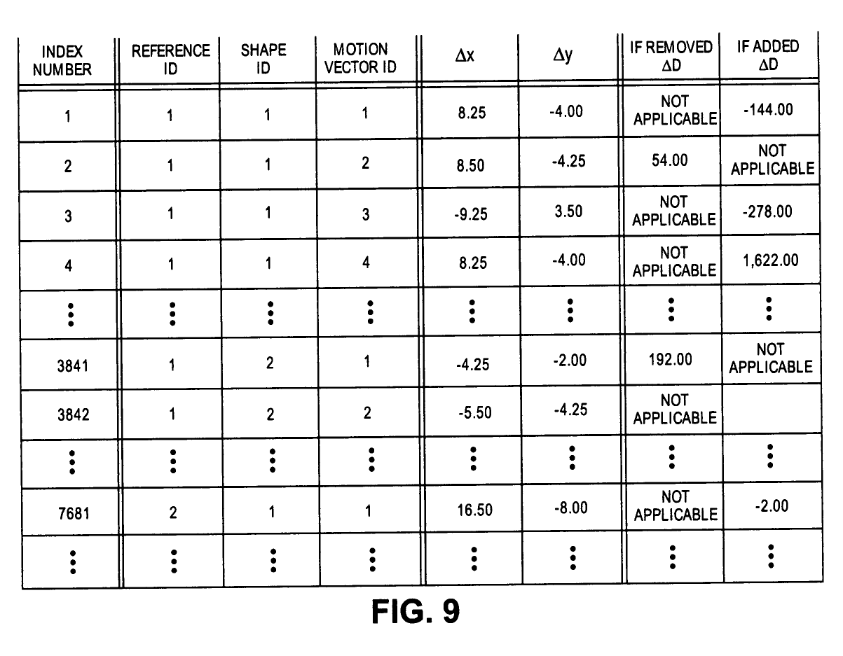

A table showing the effects of adding or removing a motion vector from the collection of motion vectors 150 is shown in FIG. 9. In this example, a motion vector that is currently in the collection may be removed, and a motion vector which is not currently in the collection may be added. When seeking to reduce the encoding rate, the motion vector selection method identifies the motion vector which, when removed from the collection, causes the smallest increase in distortion. For example, the method removes the motion vector having the smallest value of AD from the “IF REMOVED ΔD” column of FIG. 9. Similarly, when seeking to increase the encoding rate, the method adds the motion vector that results in the largest decrease in distortion. For example, the method adds the motion vector having the most negative value of ΔD from the “IF ADDED ΔD” column.

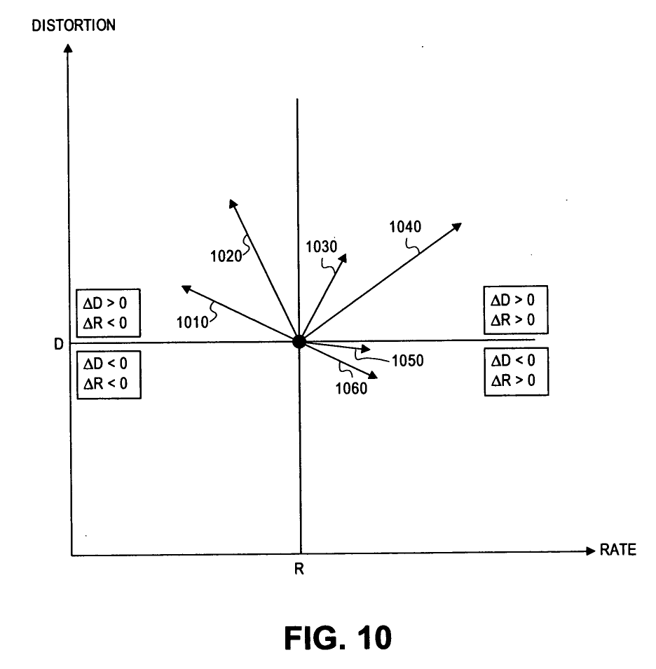

In general the method can consider cases where the rate changes are not restricted to be +/−1. This situation can occur when using a more sophisticated rate-estimation method or when allowing several simultaneous changes to the motion vector selection. In this general case, the effect of applying various candidate decisions moves the operating point from (R,D) to (R+ΔR, D+ΔD), as indicated by the arrows shown in FIG. 10. When multiple motion vectors satisfy the criteria of ΔD <0 and ΔR ≦0, one of these motion vectors is selected. Otherwise, motion vectors where ΔD/ΔR <0 are considered, and that with the smallest ΔD/ΔR is selected.

For example, arrow 1010 shows the increase in distortion from removing a motion vector. Arrow 1020 shows a larger increase in distortion from removing a different motion vector. Therefore, if a motion vector is to be removed to decrease the rate, the motion vector corresponding to arrow 1010 is a better choice, because the increase in distortion is minimized. Similarly, arrows 1030, 1040, 1050, and 1060 show the effects of adding a motion vector. The motion vectors corresponding to arrows 1030 and 1040 increase the rate and increase the distortion, and therefore these motion vectors are not added. The motion vectors corresponding to arrows 1050 and 1060 decrease the distortion. Of these, 1060 is the better choice because it results in a greater reduction in the distortion.

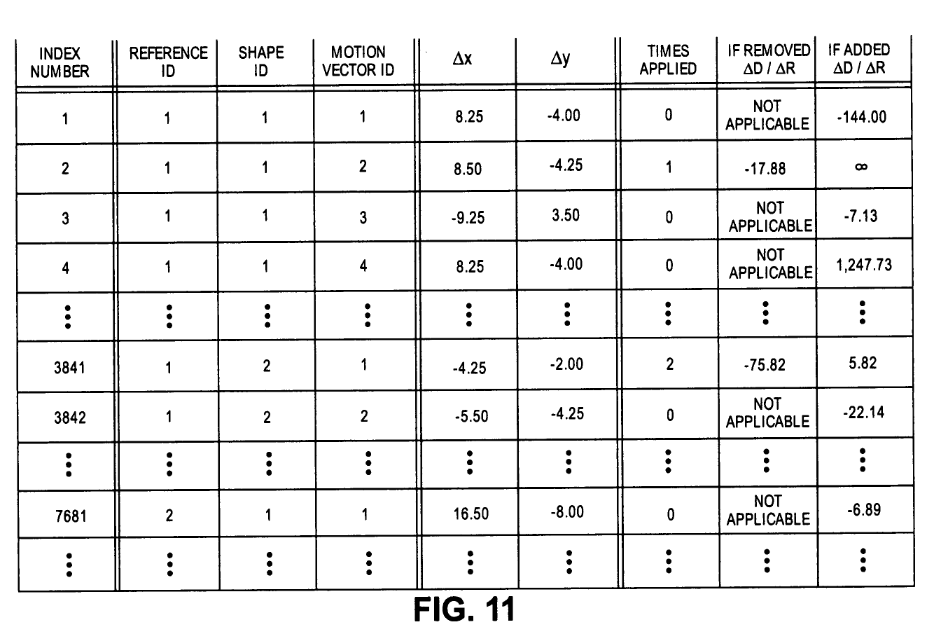

A table for the general case is shown in FIG. 11. This table shows two independent changes from the table of FIG. 9. First, motion vectors are allowed to be applied more than once, thereby altering the compensated value which is an average of mapped values. Second, if a motion vector is applied multiple times, the rate modeling is more complex than simply counting the motion vectors. Therefore, a “TIMES APPLIED” has been added to the Table. Also, the effect on the efficiency as measured by ΔA/ΔR of adding or removing a motion vector is considered, rather than the effect on the distortion.

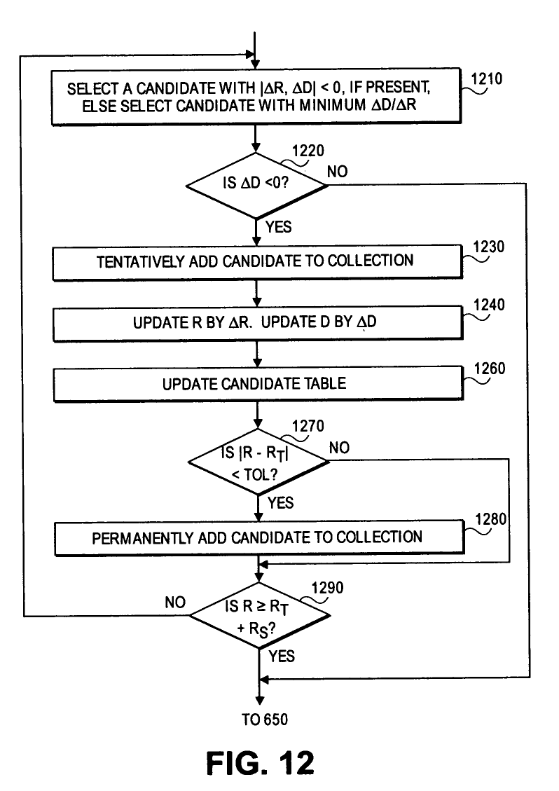

FIG. 12 shows an example of a method for adding a motion vector, as illustrated at 640 of FIG. 6. At 1210, a best candidate motion vector is selected as a potential addition to the collection of motion vectors. The best candidate is a motion vector with |ΔR, ΔD | less than 0 if such a vector is present in the set of candidate motion vectors. Otherwise, the best candidate is the motion vector with a minimum value of ΔA/ΔR. Then, at 1220, the method determines whether adding the best candidate motion vector decreases the distortion of the compensated image. If not, the method ends. If so, at 1230 the best candidate motion vector is tentatively added to the collection 150. At 1240, the values of the rate and distortion are updated. At 1260, the candidate table is updated. Then, at 1270 the method determines if the current estimated rate R is within a tolerable range of the target rate R_{T}. If so, then at 1280 the best candidate motion vector is permanently added to the collection. At 1290, if the rate R exceeds the target rate R_{T} by an amount R_{S}, the method for adding a motion vector ends by returning to block 650 in the motion vector selection method of FIG. 6. Otherwise, the method for adding a motion vector returns to 1210.

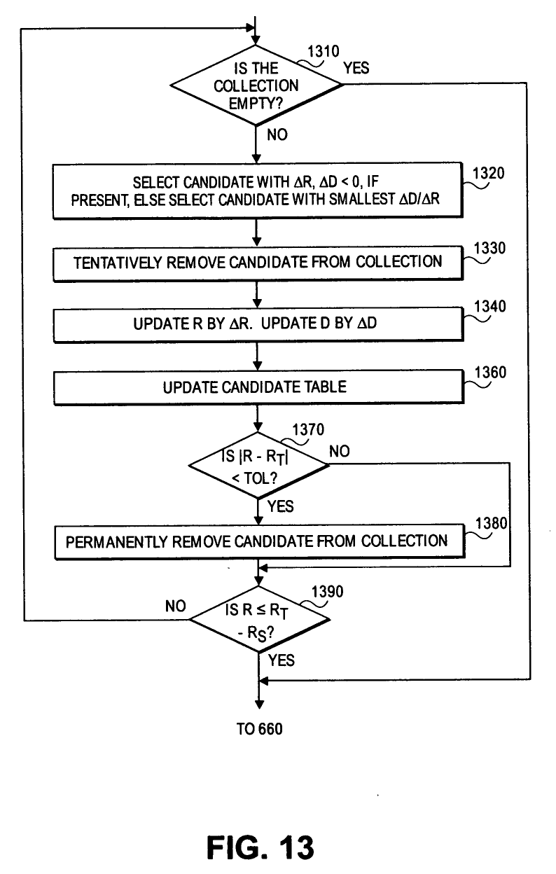

FIG. 13 shows an example of a method from removing a motion vector, as illustrated at 650 of FIG. 6. At 1310, the method determines if no motion vectors are in the collection 150 of motion vectors. If no motion vectors are present, the method ends. Otherwise, at 1320, a best candidate motion vector is selected. If a motion vector is present that reduces the distortion if removed from collection 150, such a vector is selected as the best candidate. Otherwise, the motion vector having the smallest ΔA/ΔR is selected as the best candidate for removal. At 1330, the best candidate is tentatively removed from the collection of motion vectors. AT 1340, the values for the rate R and the distortion D are updated. At 1360, the candidate table is updated. Then, at 1370 the method determines if the rate R is within a tolerable range of the target rate R_{T}. If so, then at 1380 the candidate motion vector is permanently removed from the collection 150. At 1390, if the rate R is less than the target rate R_{T} by an amount R_{S}, the method for removing a motion vector ends by returning to block 660 in the motion vector selection method of FIG. 6. Otherwise, the method for removing a motion vector returns to 1310.

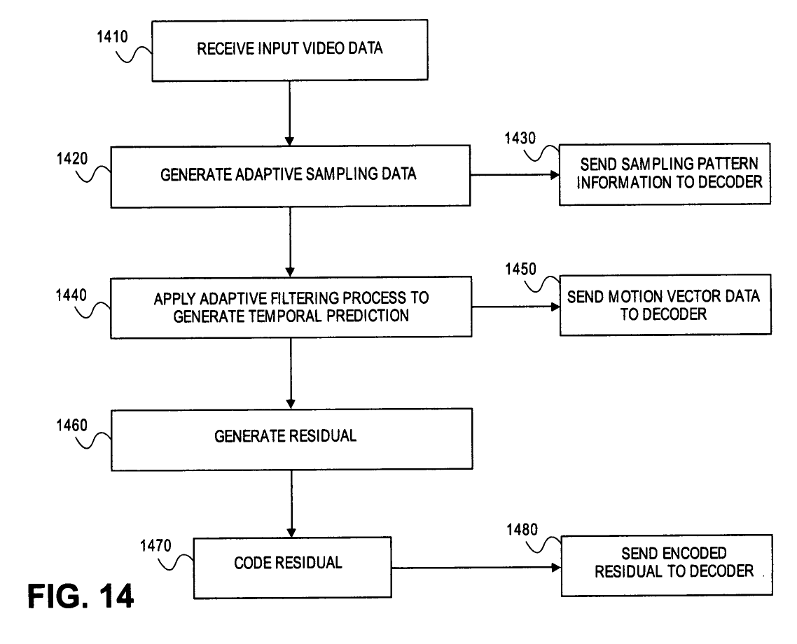

In one embodiment, the motion vector selection method is used in video coding for encoding an image (or frame, or field) of video data, as shown in FIG. 14. At 1410, the encoder receives an input target image. A set of reference images, which contain decoded image data related to the target image, is available to the encoder during the encoding process, and also to the decoder during the decoding process. At 1420, the encoder generates an irregular sampling, or distribution, of motion vectors associated with the target image. At 1430, the sampling pattern information (e.g., bits to represent the pattern) is transmitted to a decoder. The method shown in FIG. 6 can be used to generate the adaptive sampling pattern.

At 1440, a temporal prediction filtering process is applied to the irregular motion sampling pattern. This adaptive filtering process uses the motion vectors, irregular sampling pattern, and reference images to generate a prediction of the target image. At 1450, the motion vector values are coded and sent to the decoder. At 1460, a residual is generated, which is the actual target data of the target image minus the prediction error from the adaptive filtering process. At 1470, the residual is coded and, at 1480, is sent to the decoder.

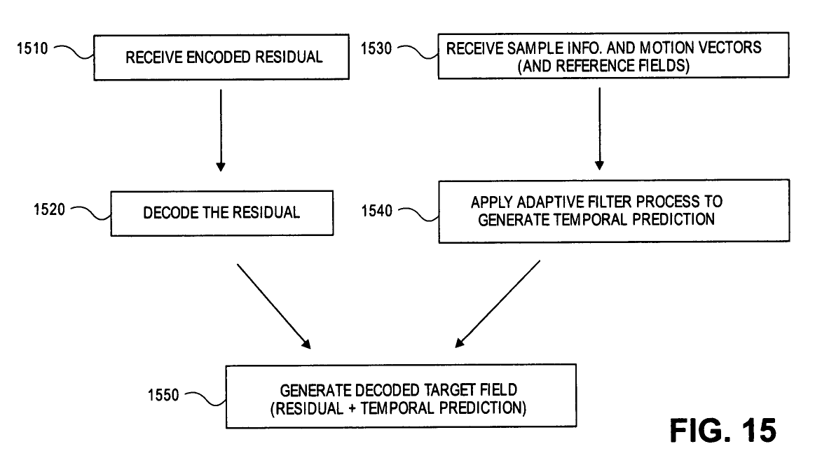

In another embodiment, the adaptive sampling pattern of motion vectors is used in decoding a image (or frame, or image) of video data, as shown in FIG. 15. At 1510, an encoded residual is received. At 1520, the decoder decodes the received encoded residual. At 1530, the decoder receives the sample pattern information, reference images, and motion vector values. Then, at 1540 the decoder applies the adaptive temporal filter procedure to generate the temporal prediction. At 1550, the decoded target image is generated by adding the decoded residual to the temporal prediction.

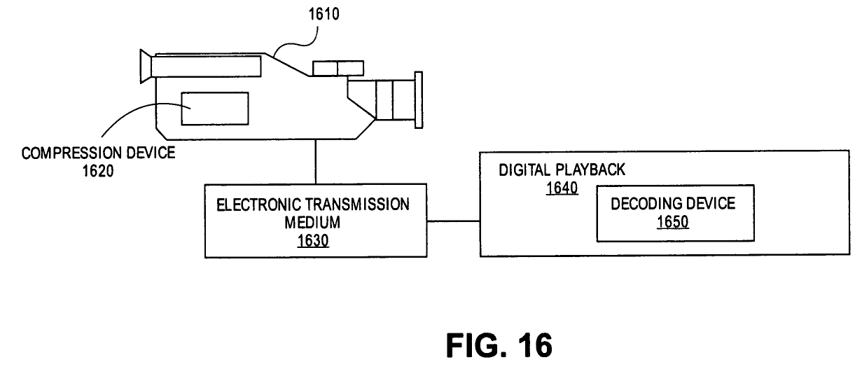

FIG. 16 shows an example of a system that uses the adaptive area of influence filter. A digital video camera 1610 captures images in an electronic form, and processes the images using compression device 1620, which uses the motion vector selection method during the compression and encoding process. The encoded images are sent over an electronic transmission medium 1630 to digital playback device 1640. The images are decoded by decoding device 1650, which uses the filter during the decoding process. Camera 1610 is illustrative of various image processing apparatuses (e.g., other image capture devices, image editors, image processors, personal and commercial computing platforms, etc.) that include embodiments of the invention. Likewise, decoding device 1650 is illustrative of various devices that decode image data.

While the invention is described in terms of embodiments in a specific system environment, those of ordinary skill in the art will recognize that the invention can be practiced, with modification, in other and different hardware and software environments within the spirit and scope of the appended claims.

1. A method carried out by an electronic data processor, comprising:
receiving a set of motion vectors; and
using a rate-distortion criterion to modify the set of motion vectors.

2. The method of claim 1, wherein using the rate-distortion criterion comprises:
adding or removing one or more motion vectors in the set to reach an approximate target rate.

3. The method of claim 1, wherein using the rate-distortion criterion comprises:
calculating a distortion for the set of motion vectors; and
adding a motion vector to the set to reduce the distortion.

4. The method of claim 1, wherein using the rate-distortion criterion comprises:
for each motion vector in the set, determining a change in distortion that results from removing the motion vector from the set;
if removing a motion vector causes a change in distortion that reduces distortion, then removing the motion vector that reduces distortion;
if removing each motion vector in the set causes a change in distortion that increases distortion, then removing the motion vector whose removal causes a minimum increase in distortion from the set.

5. The method of claim 1, wherein using the rate-distortion criterion comprises:
for each motion vector in the set, determining a change in distortion that results from removing the motion vector from the set, determining a change in rate that results from removing the motion vector from the set, and determining a ratio between the change in distortion and the change in rate; and
removing from the set a motion vector whose removal causes a minimum change in the ratio.

6. The method of claim 1, wherein using the rate-distortion criterion comprises:
for each motion vector in the set, determining a change in distortion that results from adding the motion vector to the set, determining a change in rate that results from adding the motion vector to the set, and determining a ratio between the change in distortion and the change in rate; and
adding to the set a motion vector whose addition causes a minimum change in the ratio.

7. An apparatus comprising:
a motion vector selection device that receives a set of motion vectors; and
a candidate motion vector determination device that uses a rate-distortion criterion to modify the set of motion vectors.

8. The apparatus of claim 7, wherein the candidate motion vector determination device uses the rate-distortion criterion to add or remove one or more motion vectors in the set to reach an approximate target rate.

9. The apparatus of claim 7, wherein the candidate motion vector determination device calculates a distortion for the set of motion vectors, and adds a motion vector to the set to reduce the distortion.

10. The apparatus of claim 7, wherein the candidate motion vector determination device is configured to use the rate-distortion criterion by
for each motion vector in the set, determining a change in distortion that results from removing the motion vector from the set;
if removing a motion vector causes a change in distortion that reduces distortion, then removing the motion vector that reduces distortion;
if removing each motion vector in the set causes a change in distortion that increases distortion, then removing the motion vector whose removal causes a minimum increase in distortion from the set.

11. The apparatus of claim 7, wherein the candidate motion vector determination device is configured to use the rate-distortion criterion by
for each motion vector in the set, determining a change in distortion that results from removing the motion vector from the set, determining a change in rate that results from removing the motion vector from the set, and determining a ratio between the change in distortion and the change in rate; and
removing from the set a motion vector whose removal causes a minimum change in the ratio.

12. The apparatus of claim 7, wherein the candidate motion vector determination device is configured to use the rate-distortion criterion by
for each motion vector in the set, determining a change in distortion that results from adding the motion vector to the set, determining a change in rate that results from adding the motion vector to the set, and determining a ratio between the change in distortion and the change in rate; and
adding to the set a motion vector whose addition causes a minimum change in the ratio.

13. A computer readable medium storing a computer program of instructions which, when executed by a processing system, cause the system to perform a method comprising:
receiving a set of motion vectors; and
using a rate-distortion criterion to modify the set of motion vectors.

14. The computer readable medium of claim 13, wherein using the rate-distortion criterion comprises:
adding or removing one or more motion vectors in the set to reach an approximate target rate.

15. The computer readable medium of claim 13, wherein using the rate-distortion criterion comprises:
calculating a distortion for the set of motion vectors; and
adding a motion vector to the set to reduce the distortion.

16. The computer readable medium of claim 13, wherein using the rate-distortion criterion comprises:
for each motion vector in the set, determining a change in distortion that results from removing the motion vector from the set;
if removing a motion vector causes a change in distortion that reduces distortion, then removing the motion vector that reduces distortion;
if removing each motion vector in the set causes a change in distortion that increases distortion, then removing the motion vector whose removal causes a minimum increase in distortion from the set.

17. The computer readable medium of claim 13, wherein using the rate-distortion criterion comprises:
for each motion vector in the set, determining a change in distortion that results from removing the motion vector from the set, determining a change in rate that results from removing the motion vector from the set, and determining a ratio between the change in distortion and the change in rate; and
removing from the set a motion vector whose removal causes a minimum change in the ratio.

18. The computer readable medium of claim 13, wherein using the rate-distortion criterion comprises:
for each motion vector in the set, determining a change in distortion that results from adding the motion vector to the set, determining a change in rate that results from adding the motion vector to the set, and determining a ratio between the change in distortion and the change in rate; and
adding to the set a motion vector whose addition causes a minimum change in the ratio.
